(19) United States
(12) Patent Application Publication
(10) Pub. No.: US 2020/0185140 A1
(43) Pub. Date: Jun. 11, 2020

(54) Semi-Hybrid Transformer Core

(71) Applicant: ABB Schweiz AG, Baden (CH)

(72) Inventor: Manoj Pradhan, Bålsta (SE)

(21) Appl. No.: 16/466,079

(22) PCT Filed: Nov. 17, 2017
(86) PCT No.: PCT/EP2017/079631

§ 371 Date: Jun. 3, 2019

(30) Foreign Application Priority Data
Dec. 2, 2016 (EP) 16201865.9

(51) Int. Cl. H01F 27/26; H01F 41/02

(52) U.S. Cl. CPC H01F 27/26; H01F 41/0206

(57) ABSTRACT

There is provided a transformer core. The transformer core comprises a first yoke and a second yoke. The transformer core comprises at least two limbs extending between the first yoke and the second yoke. The first yoke is of grain-oriented steel. At least one of the second yoke and one of the at least two limbs is of amorphous steel. A method of manufacturing such a transformer core is also disclosed.

### TECHNICAL FIELD

The present disclosure relates to transformer cores, especially semi-hybrid transformer cores which combine parts of amorphous steel with parts of grain-oriented steel.

### BACKGROUND

Over the past decades, communities all over the world have made concerted efforts to reduce the risk of global warming. Unfortunately, there is no single unique solution to the problem. Thus, during the coming decades energy efficiency will be a critical factor in reducing carbon emissions and fighting global warming. The power generation industry and transmission and distribution industries (T&D) contribute to a large part of energy losses in the society. The losses in T&D systems alone are total 10% of a global average of the T&D energy transferred.

There is thus a need for investments in efficient use of energy, in the energy efficiency of electric power infrastructures and in renewable resources. Development of an efficient system for using electricity may enable larger scale use of primary energy in the form of electricity compared to the situation today.

Contributing to at least one-third of total MD losses, transformers and shunt reactors are commonly the most expensive components in the power system and hence efficient design of these power devices could reduce the MD losses.

EP2685477 discloses a hybrid transformer core. The hybrid transformer core comprises a first yoke of amorphous steel and a second yoke of amorphous steel. The hybrid transformer core further comprises at least two limbs of grain-oriented steel extending between the first yoke and the second yoke. Advantageously the hybrid transformer core provides improvements for domain refined steel allowing thinner steel sheets than currently in use. The combination of amorphous isotropic core materials with highly anisotropic and domain refined steel in transformers are energy efficient.

However, there is still a need for an improved transformer design.

### SUMMARY

In view of the above, an object of the present disclosure is to provide an improved transformer design resulting in low losses.

According to a first aspect there is provided a transformer core. The transformer core comprises a first yoke and a second yoke. The transformer core comprises at least two limbs extending between the first yoke and the second yoke. The first yoke is of grain-oriented steel. At least one of the second yoke and one of the at least two limbs is of amorphous steel.

Advantageously the transformer core has a simpler manufacturing process compared to transformer cores where both yokes are made of amorphous material.

Advantageously the transformer core has a loss reduction is in the order of 10-15% compared to traditional transformer cores with both yokes and all limbs of grain-oriented steel. The loss reduction is mainly due to two reasons; firstly the use of amorphous steel in certain parts of the transformer core, and secondly due to better flux distribution in joints between yokes and limbs where one is of grain-oriented steel and the other is of amorphous steel compared to joints between yokes and limbs both being of grain-oriented steel. Amorphous steel generally has comparatively low loss, about 30% compared to grain-oriented steel.

Advantageously the transformer core has higher efficiency than transformer cores with both yokes and all limbs of grain-oriented steel and lower life cycle cost and direct cost than transformer cores where both yokes are made of amorphous material.

According to a second aspect there is provided a method for manufacturing a transformer core according to the first aspect. The method comprises placing the second yoke and attaching the at least two limbs to the second yoke in horizontal orientation to form an initial arrangement. The method comprises raising the initial arrangement to vertical orientation and placing windings on at least one of the at least two limbs to form an intermediate arrangement. The method comprises attaching the first yoke to the at least two limbs.

Advantageously this is an effective manufacturing process for a processor core according to the first aspect.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIGS. 1 to 8 illustrate transformer cores according to embodiments; and

FIG. 9 is a flowchart for a method of manufacture of a transformer core as illustrated in any one of FIGS. 1 to 8.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

In general terms, transformers are commonly used to transfer electrical energy from one circuit to another through inductively coupled conductors. The inductively coupled conductors are defined by the transformer's coils. A varying current in the first or primary winding creates a varying magnetic flux in the transformer's core and thus a varying magnetic field through the secondary winding.

Some transformers, such as transformers for use at power or audio frequencies, typically have cores made of high permeability silicon steel. The steel has a permeability many times that of free space and the core thus serves to greatly reduce the magnetizing current and confine the flux to a path which closely couples the windings.

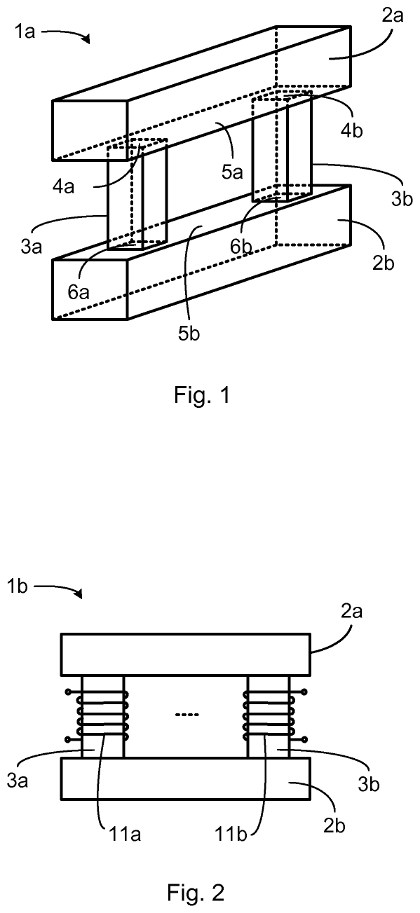

FIG. 1 is a perspective view of a transformer core 1a according to an embodiment. The vertical portions (around which windings are wound) of the transformer core 1a are commonly referred to as limbs or legs 3a, 3b and the top and bottom portions of the transformer core 1a are commonly referred to as yokes 2a, 2b.

In common hybrid transformer cores the yokes 2a, 2b are made from amorphous steel whereas the limbs 3a, 3b are made from grain-oriented core steel. Commonly the magnetic core is composed of a stack of thin silicon-steel lamination. For 50 Hz transformers the laminates are typically in the order of about 0.17-0.35 mm thick.

The disclosed embodiments relate to transformer cores, especially such transformer cores which combine parts of amorphous steel with parts of grain-oriented steel. The transformer core 1a of FIG. 1 will now be described in more detail.

The transformer core 1a comprises a first yoke 2a and a second yoke 2b. The first yoke 2a is of grain-oriented steel. The second yoke 2b is either of grain-oriented steel or of amorphous steel.

The transformer core 1a comprises at least two limbs 3a, 3b. The at least two limbs 3a, 3b extend between the first yoke 2a and the second yoke 2b. That is, the limbs 3a, 3b are coupled to the yokes 2a, 2b. Particularly, a first end 4a, 4b of each one of the limbs 3a, 3b is coupled to a first surface 5a of the first yoke 2a. A second end 6a, 6b of each one of the limbs 3a, 3b is coupled to a second surface 5b of the second yoke 2b. The limbs 3a, 3b are either of grain-oriented steel or amorphous steel.

In particular, at least one of the second yoke 2b and one of the at least two limbs 3a, 3b is of amorphous steel. The transformer core 1a may thus be regarded as a semi-hybrid core.

Aspects of the first yoke 2a will now be disclosed.

As disclosed above, the first yoke 2a is of is of grain-oriented steel. According to an embodiment the first yoke 2a is composed of a plurality of stacked limb plates of grain-oriented steel.

According to an embodiment, the first yoke 2a is a top yoke (and hence the second yoke 2b is a bottom yoke). That is, during operation of the transformer core 1a, the transformer core 1a oriented such that the first yoke 2a is positioned vertically higher than the second yoke 2b.

Aspects of the second yoke 2b will now be disclosed.

According to an embodiment, the second yoke 2b is of amorphous steel. Preferably the second yoke 2b is then composed of at least one yoke beam, each yoke beam comprising a plurality of stacked yoke plates 8 of amorphous steel, as illustrated in FIG. 4. As a non-limiting example, depending on e.g. the thickness of the yoke plates 8 used in the design, in the order of 5 to 10 yoke plates 8 (each defined by an amorphous tape) could be used to approximately match the thickness of the lamination thickness of the grain oriented steel.

The stacked plurality of yoke plates 8 may be glued together. The second yoke 2b may therefore be regarded as a glued package where the mechanical strength is obtained by the glue. According to an embodiment the second yoke is dimensioned according to its saturation flux limit. Alternatively, the second yoke 2b is of grain oriented steel. The the second yoke 2b could then be composed of a plurality of stacked limb plates of grain-oriented steel.

Aspects of the limbs 3a, 3b will now be disclosed.

There could be different ways to select the material of the limbs 3a, 3b. For example, the limbs 3a, 3b could be of amorphous steel or grain-oriented steel; at least one of the limbs 3a, 3b could be of amorphous steel and at least one other of the limbs 3a, 3b could be of grain-oriented steel. That is, according to an embodiment, those of the at least two limbs that are not of amorphous steel are of grain-oriented steel. However, alternatively, all limbs 3a, 3b are of grain-oriented steel.

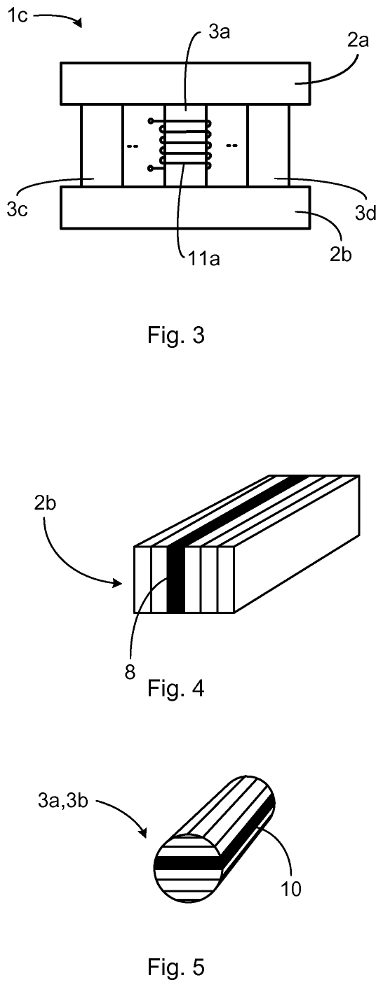

The number of limbs 3a, 3b may vary. Further, some of the limbs may be wound and some of the limbs may be unwound. FIG. 2 illustrates a transformer core 1b where the two limbs 3a, 3b each have a winding 11a, 11b, thus forming wound limbs 3a, 3b. In general terms, the transformer core 1b could have at least two wound limbs 3a, 3b. FIG. 3 illustrates a transformer core 1c comprising three limbs 3a, 3c, 3d. The limb 3a is placed between the limbs 3c, 3d. The limbs 3c, 3d may therefore be regarded as side limbs. The limb 3a has a winding 11a, thus forming a wound limb 3a. The limbs 3c, 3d do not have any windings, thus forming unwound limbs 3c, 3d. In general terms, the transformer core 1c could have at least one wound limb 3a provided between the two unwound limbs 3c, 3d.

There could be different ways to select which of the limbs 3a, 3b, 3c, 3d to be of amorphous steel and which of the limbs 3a, 3b, 3c, 3d to be of grain-oriented steel. Whether a limb is to be of amorphous steel or grain-oriented steel could depend on whether the limb is wound or unwound. For example, the wound limbs 3a, 3b could be of grain-oriented steel. Hence, according to an embodiment where at least one of the at least two limbs 3a, 3b, 3c, 3d is wound, all limbs 3a, 3b that are wound are of grain-oriented steel. For example, the unwound limbs 3c, 3d could be of amorphous steel. Hence, according to an embodiment where at least one of the at least two limbs 3a, 3b, 3c, 3d is unwound, all limbs 3c, 3d that are unwound are of amorphous steel. For example, the side limbs 3c, 3d could be of amorphous steel. Hence, according to an embodiment where two of the at least two limbs 3a, 3b, 3c, 3d are side limbs 3c, 3d, the side limbs 3c, 3d are of amorphous steel. However, also other combinations of use of amorphous steel and grain-oriented steel of the limbs 3a, 3b, 3c, 3d are possible.

For example, each limb 3a, 3b of grain-oriented steel could be composed of a stacked plurality of limb plates to of grain-oriented steel. FIG. 5 illustrates a limb 3a, 3b having a plurality of limb plates to. The plurality of limb plates to are preferably glued or bonded.

In the illustrations of FIGS. 2 and 3 there is a single winding 11a, 11b on each would limb 3a, 3b. However, as the skilled person understands, there could be at least two windings 11a, 11b (such as three windings 11a, 11b) on each wound limb 3a, 3b. Hence, each winding 11a, 11b should be interpreted as representing at least one winding.

Aspects of attachment of the limbs 3a, 3b, 3c, 3d to the yokes 2a, 2b will now be disclosed.

There could be different ways to attach the limbs 3a, 3b, 3c, 3d to the yokes 2a, 2b.

According to an embodiment, all limbs 3a, 3b, 3c, 3d are attached to at least one of the yokes 2a, 2b using a step-lap joint. By making a step wise shift of the joints it is possible to reduce the magnetization losses in the joints between the limbs 3a, 3b, 3c, 3d and the yokes 2a, 2b, due to minimization cross flow of fluxes. Examples of attaching limbs 3a, 3b, 3c, 3d to yokes 2a, 2b using a step-lap joint are provided in U.S. Pat. No. 4,200,854 A and in S. V. Kulkarni, S. A. Khaparde, “Transformer engineering: design and practice”, CRC Press, 2004.Chapter 2, page 39-41. Step-lap joints could be designed to have one lamination of grain-oriented steel against a single bunch of tapes of amorphous steel or it could have multiple one laminations of grain-oriented steel against multiple bunches of tapes of amorphous steel.

According to another embodiment, all limbs 3a, 3b, 3c, 3d are attached to at least one of the yokes 2a, 2b using a butt-lap joint. Examples of attaching limbs 3a, 3b, 3c, 3d to yokes 2a, 2b using a butt-lap joint is provided in S. V. Kulkarni, S. A. Khaparde, “Transformer engineering: design and practice”, CRC Press, 2004.Chapter 2, page 39-41.

It could be that all limbs 3a, 3b, 3c, 3d are attached to both the yokes 2a, 2b using a step-lap joint, or that all limbs 3a, 3b, 3c, 3d are attached to both the yokes 2a, 2b using a butt-lap joint. Alternatively, all limbs 3a, 3b, 3c, 3d are attached to one of the yokes 2a, 2b using a step-lap joint and to the other of the yokes 2a, 2b using a butt-lap joint. In general terms, step-lap joints could be superior to butt-lap joints in terms of performance loss. However, this difference is smaller for joints between grain-oriented steel and amorphous steel and for joints between amorphous steel and amorphous steel compared to joints between grain-oriented steel and grain-oriented steel.

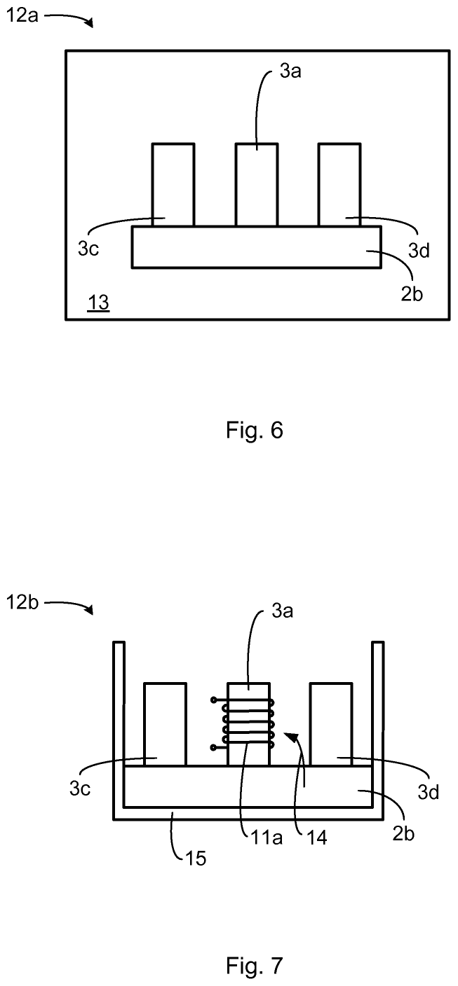

A method for manufacturing a transformer core 1a, 1b, 1c according to any of the embodiments disclosed above will now be disclosed with reference to the flowchart of FIG. 9. Parallel references are also made to FIGS. 6, 7, and 8 which illustrate a schematic assembly sequence of the transformer core 1a, 1b, 1c.

The method comprises placing (step S102) the second yoke 2b and attaching the at least two limbs 3a, 3b, 3c, 3d to the second yoke 2b in horizontal orientation to form an initial arrangement 12a.

FIG. 6 illustrates a (bottom) second yoke 2b made of amorphous steel being provided on a horizontal surface, such as on a table top 13. The second yoke 2b yoke is stacked together with three limbs 3a, 3b, 3c of grain-oriented steel on the horizontal surface to form the initial arrangement 12a.

The method comprises raising (step S104) the initial arrangement 12a to vertical orientation and placing windings 11a, 11b on at least one of the at least two limbs 3a, 3b, 3c, 3d to form an intermediate arrangement 12b (i.e., windings 11a, 11b are placed on all limbs 3a, 3b, 3c, 3d that are to be wound).

FIG. 7 illustrates the initial arrangement 12a of FIG. 6 after having been raised (as indicated by arrow 14) to have a vertical orientation. The initial arrangement 12a could be raised by means of a core holding arrangement 15. Then windings 11a are assembled on limb 3a to form the intermediate arrangement 12b.

The method comprises attaching (step S106) the first yoke 2a to the at least two limbs 3a, 3b, 3c, 3d.

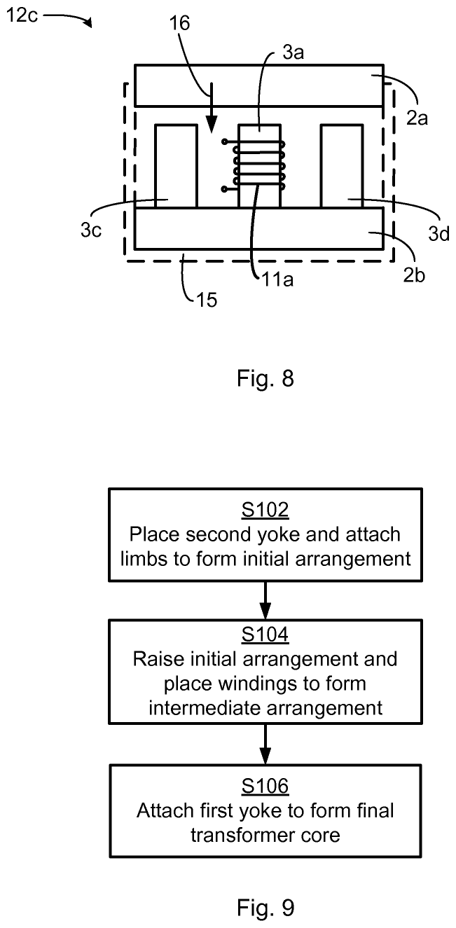

FIG. 8 illustrates intermediate arrangement 12b of FIG. 7 when being provided (as indicated by arrow 16) with a (top) first yoke 2a to form a complete arrangement 12C. The complete arrangement 12C is then removed from the core holding arrangement 15. The illustrated complete arrangement 12C thus corresponds to the transformer core 1c of FIG. 3.

The herein disclosed transformer cores may be provided in a reactor. There is thus provided a reactor comprising at least one transformer core as herein disclosed.

Hence, the transformer cores according to embodiments as schematically illustrated in FIGS. 1-8 could equally well be a reactor core. In general terms, with regard to reactors (inductors), these comprise a core which mostly is provided with only one winding. In other respects, what has been stated above concerning transformers is substantially relevant also to reactors.

The reactor may be a shunt reactor or a series reactor. The herein disclosed transformer core may according to one embodiment be applied in reactors with air as limbs without electrical core steel. Such reactors are preferably suitable for a reactive power in the region of kVAR (volt-ampere reactive) to a few MVAR. The herein disclosed transformer core may according to another embodiment be applied in reactors limbs with air gaps with (electrical) core steel. Such reactors are preferably suitable for a reactive power in the region of several MVAR.

The invention has mainly been described above with reference to a few embodiments. However, as is readily appreciated by a person skilled in the art, other embodiments than the ones disclosed above are equally possible within the scope of the invention, as defined by the appended patent claims. For example, generally, since the amorphous yokes can be built up of parallel widths of existing amorphous bands, the disclosed transformer core is not limited to any maximum size.

1. A transformer core (1a, 1b, 1c), comprising:
a first yoke (2a) and a second yoke (2b); and
at least two limbs (3a, 3b, 3c, 3d) extending between the first yoke and the second yoke;
wherein the first yoke (2a) is of grain-oriented steel, and at least one of the second yoke (2b) and one of the at least two limbs (3a, 3b, 3c, 3d) is of amorphous steel.

2. The transformer core (1a, 1b, 1c) according to claim 1, wherein those of the at least two limbs (3a, 3b, 3c, 3d) that are not of amorphous steel are of grain-oriented steel.

3. The transformer core (1a, 1b, 1c) according to claim 1, wherein the second yoke (2b) is of amorphous steel.

4. The transformer core (1a, 1b, 1c) according to claim 3, wherein the second yoke (2b) is composed of at least one yoke beam, each yoke beam comprising a plurality of stacked yoke plates (8) of amorphous steel.

5. The transformer core (1a, 1b, 1c) according to claim 3, wherein the second yoke (2b) is dimensioned according to its saturation flux limit.

6. The transformer core (1a, 1b, 1c) according to claim 1, wherein all limbs (3a, 3b, 3c, 3d) are of grain-oriented steel.

7. The transformer core (1a, 1b, 1c) according to claim 1, wherein at least one of the limbs (3a, 3b, 3c, 3d) is of grain-oriented steel.

8. The transformer core (1a, 1b, 1c) according to claim 1, wherein the first yoke (2a) is a top yoke.

9. The transformer core (1a, 1b, 1c) according to claim 1, wherein at least one of the at least two limbs (3a, 3b) is wound, wherein all limbs (3a, 3b) that are wound are of grain-oriented steel.

10. The transformer core (1a, 1b, 1c) according to claim 1, wherein at least one of the at least two limbs (3c, 3d) is unwound, wherein all limbs (3c, 3d) that are unwound are of amorphous steel.

11. The transformer core (1a, 1b, 1c) according to claim 1, wherein two of the at least two limbs (3c, 3d) are side limbs (3c, 3d), wherein the side limbs (3c, 3d) are of amorphous steel.

12. The transformer core (1a, 1b, 1c) according to claim 1, wherein the first yoke (2a) is composed of a plurality of stacked limb plates (10) of grain-oriented steel.

13. The transformer core (1a, 1b, 1c) according to claim 1, wherein all limbs (3a, 3b, 3c, 3d) are attached to at least one of the yokes using a step-lap joint.

14. The transformer core (1a, 1b, 1c) according to claim 1, wherein all limbs (3a, 3b, 3c, 3d) are attached to at least one of the yokes using a butt-lap joint.

15. A method for manufacturing a transformer core (1a, 1b, 1c) according to claim 1, the method comprising:
placing the second yoke (2b) and attaching the at least two limbs (3a, 3b, 3c, 3d) to the second yoke (2b) in horizontal orientation to form an initial arrangement (12a);
raising the initial arrangement (12b) to vertical orientation and placing windings (11a, 11b) on at least one of the at least two limbs (3a, 3b, 3c, 3d) to form an intermediate arrangement (12b); and
attaching the first yoke (2a) to the at least two limbs (3a, 3b, 3c, 3d).
